(19) United States
(12) Patent Application Publication
(10) Pub. No.: US 2004/0073512 A1
(43) Pub. Date: Apr. 15, 2004

(54) Unique session storage design

(76) Inventor: David Maung, Del Mar, CA (US)

Correspondence Address: Mr. Steven W. Smyrski, PILLSBURY WINTHROP LLP, Suite 2800, 725 South Figueroa Street, Los Angeles, CA, 90017-5406, US

(21) Appl. No.: 09/792,697

(22) Filed: Feb. 23, 2001

(51) Int. Cl. H04K 1/00; H04L 9/00; G06F 17/60

(52) U.S. Cl. 705/51

(57) ABSTRACT

A system and method for providing user session state across various networked machines is disclosed. The system encompasses a session saver and a sessions database centrally maintained for access by a plurality of computing devices. The system indexes each stored variant by a user defined key and a descriptive variable name. The session saver is a drop in replacement for the IIS session object that provides session state without using cookies. The session saver is divided into various subcomponents, including Csaver for providing the COM interface, OleDbSessionTable to read and write the data from an OLE database, Cconnection for retrieving a connection string from a UDL file, RegistryInfo that reads the location of the UDL file from the memory, StorageVariant enabling storage of variants in any properly configured OLE DB provider, and CcomVariantEx. Any of the operations servers generates a session key when initially contacted by the user and the session saver stores the session key and variables associated with the particular session, such as account numbers, passwords accepted, and so forth. These session keys and stored variables are available to any of the other operations servers and a procedure for retrieving these keys and variables is performed each time a session is either commenced or resumed. Each generated session key is unique and non predictable such that multiple operation servers can simultaneously generate keys without conflict.

### BACKGROUND OF THE INVENTION

1. Field of the Invention

The present invention relates generally to wireless financial transactions, and more specifically to a system for providing wireless access to and control of financial information maintained by a financial institution.

2. Description of the Related Art

Financial services are currently offered over the internet to the general population through the financial institutions themselves, or through some type of intermediate service or portal, such as Yahoo! Recent developments in access to financial institutions over the internet include access to personal account financial data, the ability to pay bills, and the ability to trade stocks. Each of these services provide access and tracking of financial positions using secure means of communication over the internet, such as SSL. For internet banking, the user can monitor his or her bank balance, recent transactions, and transfer money between accounts. Bill payment entails the bill paying entity making a payment at a predetermined time based on user authorization and debiting the amount from a designated user account. Stock trading permits the user to view his or her account details and buy or sell stocks, mutual funds, bonds, options, or other financial instruments either when the money is available or on margin from the brokerage entity. Each of these transactions is enabled by fetching the appropriate data from the financial institution (brokerage, bank, credit union, bill payment entity) and relaying that data back to the user, and permitting the user to execute some level of functionality on the data where applicable, such as executing a trade, transferring money between accounts, and so forth.

While this functionality is now becoming widely available, at the same time users have access to certain information using various types of devices, including cellular telephones, PDAs, laptop computers, two way paging devices, and Microsoft Windows CE devices. Users can access certain information using these devices over the Internet, such as accessing stock quotes, sports scores, and other limited information.

At the present time, however, there is no simple and efficient way for a user having access to these various wireless devices to have access to his or her financial information, perform financial transactions, or obtain certain financial information, such as account balances, and so forth. The reasons for this inability to obtain personal financial information over wireless networks varies, but a part of the problem has been that until now financial institutions have not seen the need nor recognized the potential market for offering wireless financial services to their customers. Certain complexities exist, such as how to present this financial data to a user across different platforms in an efficient manner, and how to provide this information and functionality quickly and securely to a user.

Additional problems exist with providing financial services to users of various wireless devices. Users frequently have access to different devices among those previously noted, where each device has different data access abilities and requirements. For example, certain cellular telephones have speed dial or commonly called telephone numbers, but do not have the ability to receive e-mail. Certain cellular telephone handsets have the ability to receive alphanumeric pages, but some cellular service providers do not support this feature while others do. Also, many PDAs do not have the ability to receive over-the-air transmissions, but can synchronize with a database, such as a database associated with a personal computer and/or network, while other PDAs have the ability to receive and edit e-mail messages. Hence the ability for a user to access, maintain, and dynamically utilize financial information is heavily dependent on the input device employed by the user.

It is therefore an object of the present invention to provide a system enabling wireless access to financial institutions that is reasonably secure, fast, and enables transactions frequently requested of financial institutions.

It is a further object of the current invention to provide a wireless financial services access system that supports a variety of wireless devices, including PDAs, laptop computers, two way pagers, and Microsoft Windows CE devices.

It is another object of the present invention to provide a wireless financial services access system that is easily implemented and maintained, is scalable and dynamic, and does not require extensive maintenance or updating by the financial institution.

### SUMMARY OF THE INVENTION

According to the present invention, there is provided a system and method for providing a unique user session across a variety of computing devices such that the user is not limited to interacting with the same computing device for an entire session. The system includes a session saver object and an associated session database.

### PROVIDE SUMMARY OF DETAILED DESCRIPTION HERE

According to the present invention, a session saver is provided that dynamically saves user sessions such that a user can submit multiple requests and each request can be addressed by any machine or server in the system determined to have the ability and capacity to address the request. For example, if one server is working on several requests while another server is not, the server having the lowest load may receive the request even though it did not initiate the user session. The current system employs a central database containing a unique ID and associated session data that may be accessed by any server in the system.

The session saver is an object accessed through encrypted DCOM. The session saver provides access to a resident in memory database and is a fully compliant OLE DB consumer. The database stores and retrieves variant data types used by the ASP environment. The session saver is a drop in replacement for the IIS session object that provides session state without using cookies.

The session saver is divided into various subcomponents, including Csaver, a class of information that provides the COM interface for the session saver, OLESessionTable, which reads and writes the data from an OLE database, Cconnection string representing a class of data providing a method to retrieve the connection string from a UDL file, RegistryInfo that reads the location of the UDL file from the system registry, thereby enabling dynamic configuration of the session saver, and StorageVariant, a session saver component built on top of CcomVariantEx enabling storage of variants in any properly configured OLE DB provider.

In operation, the session saver stores a user's state between stateless calls to the operations server. Previous systems have employed the Active Server Page (ASP) “session” feature. A user initiates a session using one of the operations servers. The server may fetch information, provide that information to the user, and the user may transmit a second request. Any of the operations servers can generate a session key when initially contacted by the user and the session saver stores the session key and variables associated with the particular session, such as account numbers, balance information, and so forth. The session key is passed to the device in a device compatible format. These stored variables are available to any of the other operations servers and a procedure for retrieving these keys and variables is performed each time a session is either commenced or resumed.

Each generated session key is unique and non predictable such that multiple operation servers can simultaneously generate keys without conflict. The system and each operation server employs a GUID generator generating a 128 bit number that is not generated by any other operation server or computer. The system adds a further layer of unpredictability by prepending the GUID with a random number based on the number of clock ticks that have passed since startup of the particular operation server and use the RSA Data Securities 56 bit key RC5 encryption algorithm. The encryption key is simply used as an identifier to uniquely identify the session, and is referenced by the operation server and any other operation server receiving a subsequent request for the initiated session.

Each operations server has its own copy of session saver, and any new operations server added immediately creates unique unpredictable session keys and provides service for any client who has stored session state with any other operations server.These and other objects and advantages of all of the aspects of the present invention will become apparent to those skilled in the art after having read the following detailed disclosure of the preferred embodiments illustrated in the following drawings.

### DESCRIPTION OF THE DRAWINGS

FIG. 1 illustrates a conceptual drawing representing the overall operation of the present system;

FIG. 2 is an embodiment of the present system;

FIG. 3 shows the hardware used at the operations center 201 to effectuate the transfer of financial data between the user and the financial institution;

FIG. 4 graphically represents the operation of each of the operational servers;

FIG. 5 is a detailed view of the parser;

FIG. 6 illustrates the components of the session saver;

FIG. 7 is a detailed illustration of the User Request Handler; and

FIG. 8 shows the details of the output deck.

### DETAILED DESCRIPTION OF THE INVENTION

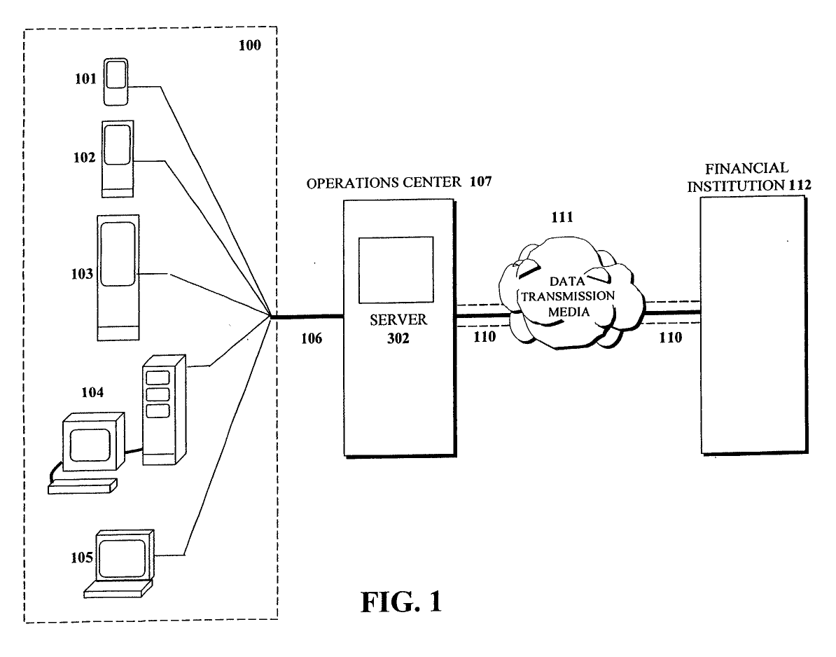

Referring now to the drawings, FIG. 1 illustrates a conceptual overview of the various articles between a user's wireless device and the financial institution. From FIG. 1, a subscriber has access to an input device, which may be one from a class of input devices 100 including, but not limited to, a cellular telephone 101, a personal digital assistant (PDA) 102, a Microsoft Windows CE device 103, a desktop personal computer 104, or a laptop personal computer 105. Other devices may be employed, such as a two-way paging device, while still within the scope of the present invention.

The input device transmits or receives information over a data link 106, such as a telephone line, dedicated computer connection, satellite connection, cellular telephone network, the Internet, or other data connection. The data link 106 is connected to an operations center 107, which offers a central location for accessing and processing information from various remote financial institutions 112. Operations center 107 provides users with access to financial information or data maintained at the financial institutions 112. The operations center 107 transmits data through a dedicated connection 110, which is preferably an IPSEC tunnel through the Internet, or a PPTP connection via the Internet. The dedicated connection 110 is provided through data transmission media 111, which may be the Internet, a Wide Area Network (WAN), or any other media used for server communication. The dedicated connection 110 provides the robustness necessary to update the subscriber and provide information in a reasonable time period. Use of a connection that is not dedicated can result in delays and service disruptions, and the Internet provides an example of a powerful and readily accessible data transmission media. Addition of financial institutions 112 or operations centers 107 to an arrangement employing the Internet is relatively simple. Note also that data link 106 may also employ the Internet for user access to the operations center 107.

In operation, the user must first access the operations center 107 using an access arrangement, such as a password verifying his or her identity and pertinent information, such as a bank or brokerage account number. The user makes a request into the subscriber device, such as a cellular telephone, to view financial data, such as his or her bank balance in a particular account. The server 108 receives the request via the data link 106 and passes the request through the dedicated connection 110 and on to the financial institution 112. The financial institution 112 processes the request for the bank balance and obtains the necessary data. The financial institution 112 obtains the requisite information and transmits the data back through the dedicated connection 110, to the operations center 107, and to the user via data link 106 to the requesting input device. To accomplish this, the financial institution 112 must include a server having a scalable, reliable and secure data access platform, such as Microsoft Exchange Server, for ready access to the requested financial information.

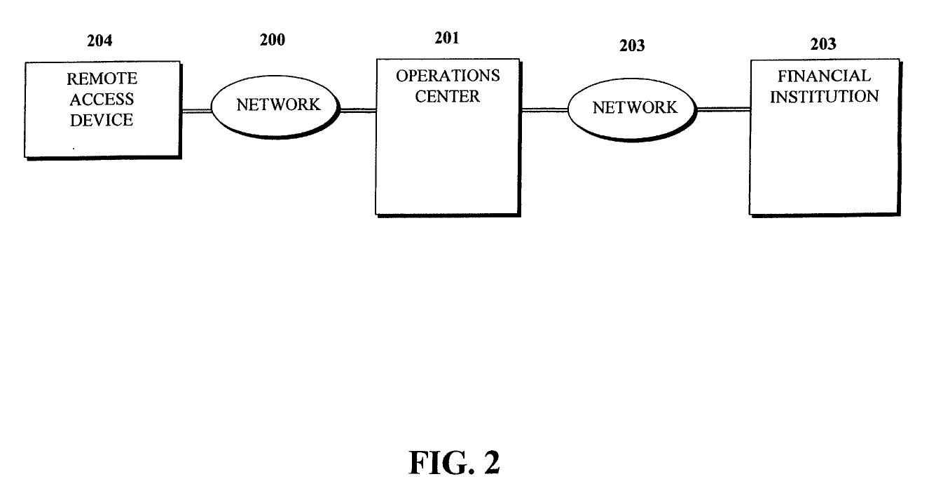

FIG. 2 illustrates an embodiment of the present invention. The embodiment allows subscribers to securely and remotely access a centralized operations center 201, which acts as an intermediary to facilitate access and manipulation of user account information residing in an independent or networked financial institution network 203 in real time. In one implementation, a wireless system subscriber, or user, by way of a remote access device 204, makes a request across a network 200 to an operations center 201, to supply subscriber or user financial information (e.g., account balances, stock pricing data, and so forth) located in a financial institution 203. The operations center 201 receives the request, authenticates the user and the user account parameters, accesses the financial institution network 203, establishes a secure session with the financial institution network 203, retrieves the requested user information, and formats the information in accordance with the display capabilities of the remote access device 204. The remote access device 204 may be connected to a “wireline” network (e.g., personal computer, kiosk, etc.) or may be connected to a wireless network (e.g., cellular phones, personal digital assistants [PDAs], Microsoft Windows CE device, etc.).

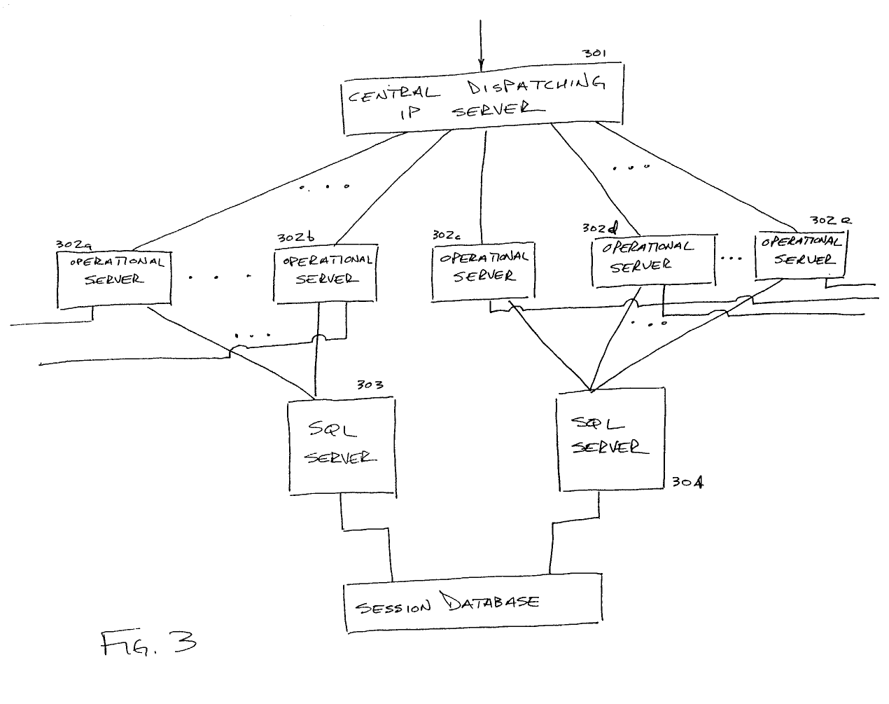

FIG. 3 illustrates the hardware used at the operations center 201 to effectuate the transfer of financial data between the user and the financial institution. The hardware comprises a central dispatching IP server 301, multiple operational servers 302 that maintain the software and perform the functionality described below, a pair of SQL servers 303 and 304 operationally connected to the multiple operational servers 302, and a session database 305 for maintaining session information. The dispatching IP server 301 performs the task of receiving incoming traffic and requests and parsing those requests to the various operational servers 302. The operational servers 302 run the software and functionality described below, and each operational server 302a, 302b, and so forth include identical software and functionality to the other operational servers to handle the incoming load and exhibit redundancy. The SQL servers 303 and 304 are each connected to approximately half of the operational servers 302 and perform session management functions on the incoming requests to manage the sessions for each particular user session. The pertinent session data is maintained on session database 305 for tracking purposes. Each of the operational servers include a telephone connection enabling secure connection to the financial institutions via the internet.

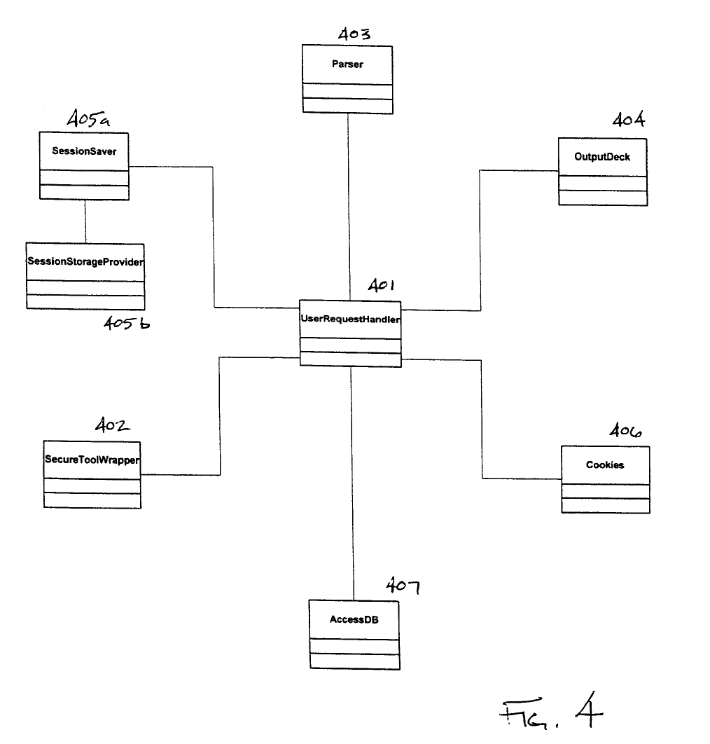

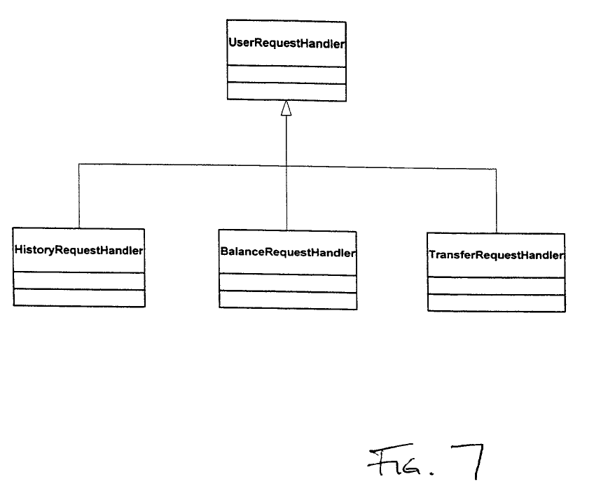

The operational servers operate in accordance with the drawing of FIG. 4. The system disclosed herein uses Active Server Pages (ASPs) in the Microsoft IIS environment. The system uses Visual Basic scripts employing various COM objects. The user initially sends a request in a predetermined format configured for his or her wireless device. For example, a user of a cellular telephone may be presented with a menu wherein she can select a digit, such as “1,” in a certain menu to request bank balance data. Alternately, if available, the user can type in a certain request, such as “balance” and transmit the query to the receiving device. Based on the known parameters for the device, and session data, the operations center 107 determines the information requested by the user and converts and relays that information using the arrangement shown in FIG. 4. From FIG. 4, User Request Handler 401 receives the user financial request and executes all necessary business logic necessary to obtain the information requested by the user and transmit the information back to the user. A detailed illustration of the User Request Handler is presented in FIG. 7, illustrating separate history request handlers, balance request handlers, and transfer request handlers. Not shown but available for FIG. 7 is a Bill Payment handler module used to pay bills. The User Request Handler 401 receives the request in a known form, such as a request for a bank balance, and initially provides security to the request using the secure tool wrapper 402, whereby the request is converted to a compatible format and transmitted from the operations center 107 to the financial institution 112 using a secure protocol via HTTP and TCP/IP, such as SSL. The secure tool wrapper wraps a third party COM object and implements HTTP GET and POST requests to the financial institution. Thus the request is transmitted to the financial institution's secure web site, where the requisite information is requested. A typical situation is that Bank ABC maintains a web site from where users can access bank account information. On the Bank ABC web site, an internet user enters her account information, passwords, and then access the requisite information over a series of web pages, where the Bank ABC maintains a tree structure of HTML pages. Bank ABC may require that a customer navigate to a third level HTML page to locate her account balance. A typical request in this environment is a request for an account balance or other pertinent information, such as the last X checks that have cleared. Data requested can include Balance, for the balance of an account, History, for the financial history for the account, such as deposits made, checks cleared, or other pertinent data, or Transfer, for performing a transfer of funds from one account to another. Balance and History each require obtaining data from the financial institution, while Transfer requires making a transaction at the financial institution. Parameters required for a transfer include the remote account location or designation, the amount of money to be transferred, and a check by the financial institution to verify that the requisite amount is in the account.

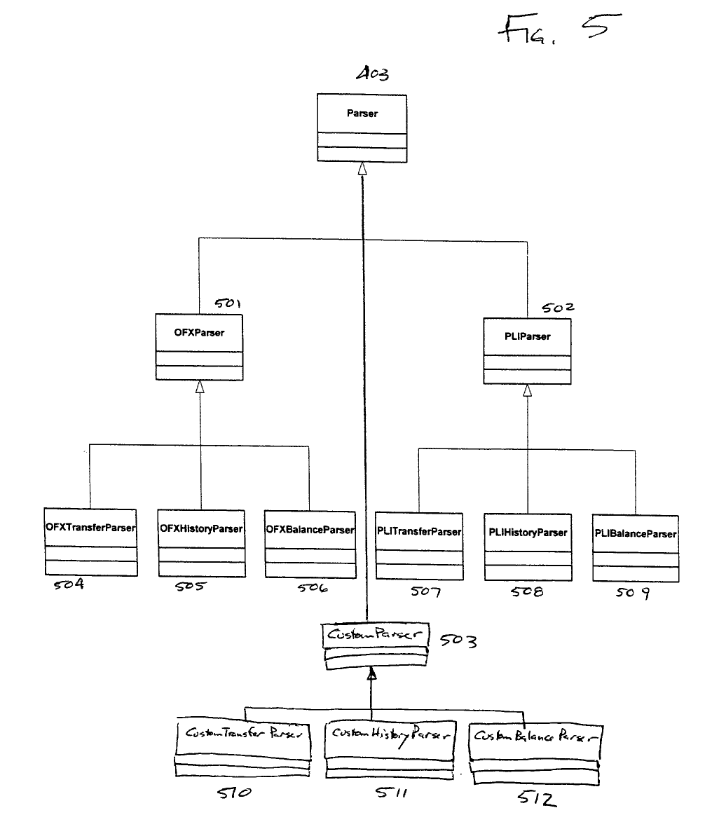

A financial institution 112 may require several interactions to process a request from a user. From the previous example, a request for a bank balance from a site having three levels of menus on the web site before locating balance requires interacting with the financial institution web site to navigate to the third level and obtain the requested data and return that data to the user with the financial web site navigation transparent to the user. The user request handler performs these interactions in a secure environment such as SSL using the secure tool wrapper to obtain the confidential financial information. The result of the interactions is returned to the user request handler 401 and passed to the parser 403 to properly parse the information and extract the necessary information satisfying the user request. Details of the parser are presented in FIG. 5.

FIG. 5. is a UML class diagram which shows the implementation of a parser from the abstract concept of a generic parser 403 to the concrete implementations such as an OFX balance parser 506. All parsers perform the same general function of parsing input received from a financial institution and returning the relevant data for the request. Parsers can be divided into three categories based on the type of financial institution handling the request. These are the OFX parser 501, the PLI parser 502, and the custom parser 503. Each of these categories can further be divided into subcategories for the type of request being sent to the financial institution. These are transfer, history, and balance. The system includes at least 9 concrete implemented parsers, namely the OFX transfer parser 504, the OFX history parser 505, the OFX balance parser 506, the PLI transfer parser 507, the PLI history parser 508, the PLI balance parser 509, the custom transfer parser 510, the custom history parser 511, and the custom balance parser 512. Custom parsers represent custom parsing required by a financial institution that does not use OFX or PLI. The user request handler calls the appropriate parser to parse the relevant information out of the result returned by the financial institution. For example, if a user requests account history from a financial institution using PLI, the PLI history parser 508 parses the information returned by the financial institution and returns the account history to the user request handler.

After the relevant information has been parsed, user request handler 401 passes the relevant information to the output deck 404 for presentation to the user. Output deck 404 prepares the relevant data for transmission to the user. For example, WML tags may be added to the output to display the information on a WML device. For a Transfer request, certain output information may be prepared in the output deck 404 for presentation, such as a verification of the requested transfer amount. Thus the output deck 404 prepares a context relevant response based on the parsed information received from the financial institution.

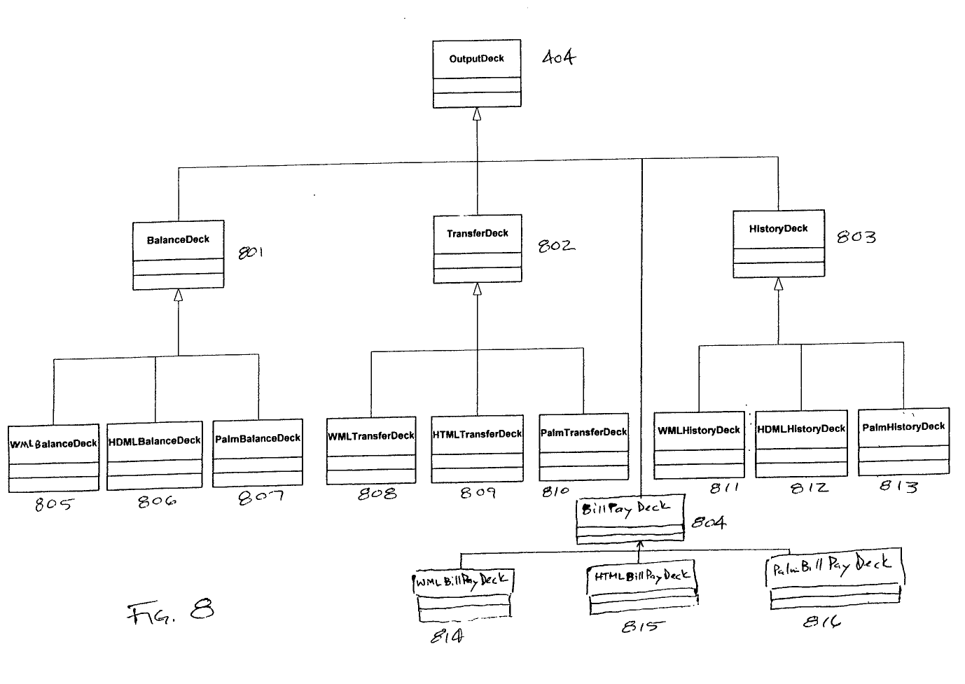

Output deck 404 is illustrated in further detail in FIG. 8. FIG. 8 is a UML class diagram showing the implementation of an output deck from the abstract output deck 404 to the concrete implementations such as the HDML balance deck 806. All output decks perform the same general function of receiving relevant information and formatting that information for output on a specific device. Output decks can be divided into categories based on function such as balance deck 801, transfer deck 802, history deck 803, and bill pay deck 804. Each of these categories can be further divided into output based on device type, namely WML, HDML, PALM, and Windows CE devices. FIG. 8 presents 12 concrete implementations of the output deck beginning with the WML balance deck 805 and ending with the PALM bill pay deck 816. The user request handler receives the relevant information from the appropriate parser and forwards the information to and output deck for formatting. For example, if the user makes a history request on a PALM device, the history information is sent to the PALM history deck for formatting.

Once the relevant data has been included in the output deck 404, information pertinent to the user session is saved using session saver 405a and session storage provider 405b. The purpose of the session saver 405a is to store session pertinent parameters such that subsequent queries received from the user do not require information already provided. For example, a user is not required to enter his account information each time he makes a query of the financial institution, as his account data is saved by session saver 405a in connection with session storage provider 405b.

Session saver 405a is an object accessed through encrypted DCOM. The session saver provides access to a resident in memory database and is a fully compliant OLE DB consumer. The database stores and retrieves variant data types used by the ASP environment. The database stores arrays of mixed types and multiple dimensions and stores and retrieves all types of variants. The system indexes each stored variant by a user defined key and a descriptive variable name. The session saver is a drop in replacement for the IIS session object that provides session state without using cookies. When used with an in memory OLE DB provider, data is maintained in memory and is secure preventing unauthorized access even in the event of a hard reboot.

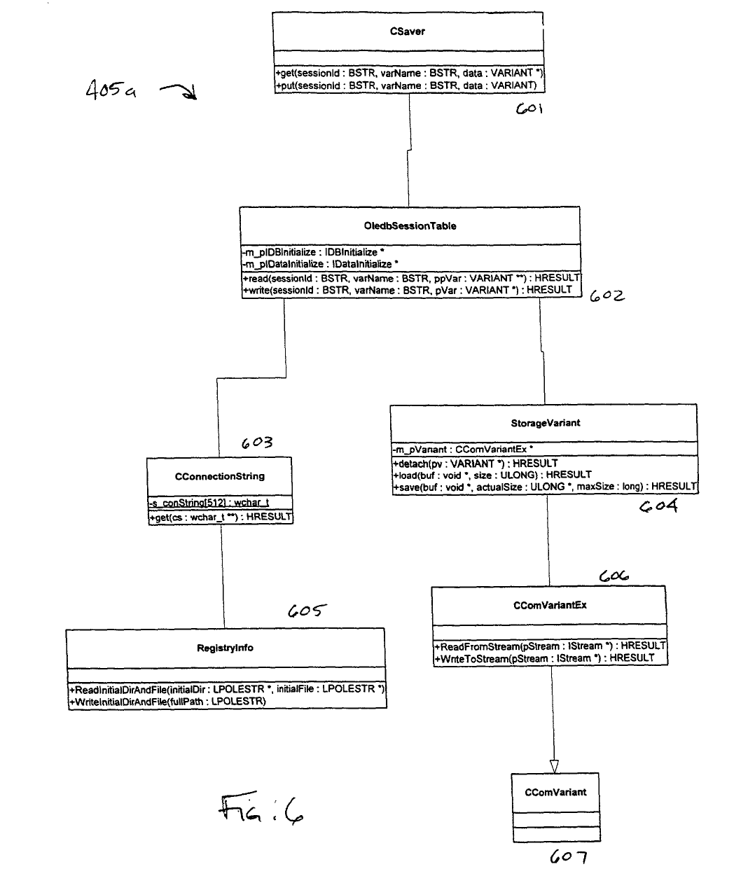

The session saver is divided into various subcomponents, illustrated in FIG. 6. CSaver 601 is a class of information that provides the COM interface for the session saver. CSaver 601 exposes the Get and Put methods used by Visual Basic ASP pages or any COM client. CSaver interfaces with the OleDbSessionTable to read and write the data from an OLE database. The OleDbSessionTable class provides interfaces to the OLE database and the methods are called from CSaver to read and write user variants. Cconnection string represents a class of data providing a method to retrieve the connection string from a UDL file. The session saver is employed with the in-memory OLE DB provider database to provide superior security while maintaining full compliance with an OLE DB consumer but may be employed with any properly configured OLE DB provider. The session saver also employs a class called RegistryInfo that reads the location of the UDL file from the system registry, thereby enabling dynamic configuration of the session saver. StorageVariant is a session saver component built on top of CcomVariantEx enabling storage of variants in any properly configured OLE DB provider. CComVariantEx is an enhancement of the Microsoft CComVariant class. CComVariant exposes the ReadFromStream and WriteToStream interfaces to store variants including multi-dimensional array variants and “by reference” variants to any stream. In the original Microsoft CComVariant class, functionality was limited to simple variants. The original Microsoft CcomVariant class did not support safe arrays or “by reference” variants. CComVariantEx implements a ReadFromStream and WriteToStream to support writing and reading of safe arrays and writing and reading by reference types. SessionStorageProvider is a class of data (Level 0 compliant) that is an OLE DB provider implementing the in memory database and used with the SessionSaver class.

In operation, the session saver stores a user's state between stateless calls to the operations server 302. Previous systems have employed the Active Server Page (ASP) “session” feature. A user initiates a session using one of the operations servers 302. The server may fetch information, provide that information to the user, and the user may transmit a second request. The session saver does not require the newly received request to be transmitted to the same server as the previous request, a procedure typically required by previous implementations of “session” features. Rather, any of the operations servers 302 generates a session key when initially contacted by the user and the session saver stores the session key and variables associated with the particular session, such as account numbers, balance information, and so forth. The session key is passed to the device in a device compatible format. These stored variables are available to any of the other operations servers and a procedure for retrieving these keys and variables is performed each time a session is either commenced or resumed.

Session saver does not rely on a browsing device's ability to store cookies. Certain devices, such as the Palm PDA do not support cookies, the system maintains state on these devices by sending the session key in encrypted form to the device as part of all links to other pages. The system does not depend on any feature of the browser for session state other than the browser ability to redirect to another page.

With the need and ability to issue and maintain different session keys for each user initiated session, key management is of great significance. Each generated session key is unique and non predictable such that multiple operation servers 302 can simultaneously generate keys without conflict. Unpredictability of keys generated prevents session spoofing. The system and each operation server 302 employs a GUID generator generating a 128 bit number that is not generated by any other operation server or computer. The system adds a further layer of unpredictability by prepending the GUID with a random number based on the number of clock ticks that have passed since startup of the particular operation server and use the RSA Data Securities 56 bit key RC5 encryption algorithm. The RSA encryption algorithm provides an encrypted message with 72 quadrillion possible decoding keys. The system, specifically the operation server 302 receiving the session, selects one encryption key at random. As soon as the operation server encrypts the session key, the system discards the encryption and decryption key and encodes the session key using Base64 to provide a text based key and add a further layer of randomness. Since the system never decodes the key, destruction of the key and decryption key provides additional security. The encryption key is simply used as an identifier to uniquely identify the session, and is referenced by the operation server and any other operation server receiving a subsequent request for the initiated session. Information in the session saver database is thereby associated with a particular session, and correlation information (session keys and information) are maintained in the session saver database, typically separate from the operation servers 302.

Session saver 405a provides a time for session timeout, such that a user failing to send a request after a predetermined time, such as five minutes, times out the session. All associated variables with that session are destroyed at time out. The session saver relies on a database to store any type of variant data provided by the user, financial institution, or intermediate source. Variant data can include objects, multidimensional arrays, and multilevel arrays (arrays of arrays). The COM interface enables connection to the session saver from any language supporting COM, including C++, Java, and Visual Basic. Session saver 405a accesses the session saver database using an OLE DB interface. Use of the OLE DB interface provides a transparent session saver object.

Each operations server has its own copy of session saver, and any new operations server added immediately creates unique unpredictable session keys and provides service for any client who has stored session state with any other operations server. Load balancing enables determination of which operations servers are busiest, and enable passing requests to idle machines on a per-request basis rather than a per session basis.

Once data pertinent to the session has been saved in the session saver 405a using session storage provider 405b, the user request handler 401 addresses any issues dealing with “cookies” related to the financial institution's web site. While many, if not all, of the interactions between the operations center 302 and financial institution web site are transparent to the user, the financial institution web site still considers the incoming requests and all traffic to be a session as if engaged by a browser at the user end. Thus, the system must be able to handle all aspects of the session without the need for user input, thus requiring handling of cookies. Cookies are data transmitted by the site to the user for storage on the user's machine for later use by the site. Cookies may either be accepted, rejected, or discarded, and internet browsers include the ability to receive and act on cookies. Thus the present system handles cookies as would a browser, but discards the majority of cookies received as unnecessary. The cookie class of object is a utility class that is called to retrieve cookies from HTTP headers, strip header strings from cookies, construct cookie strings, and perform other cookie related tasks to maintain data access functionality along with transparency to the user.

The final function performed by the User Request Handler 401 is to record session statistics such as user ID, time, and request performed. No information will be stored that would allow other users to access account information, i.e., account numbers, passwords, account balances, and history are not stored in the access database. The Access database 407 tracks statistics for billing purposes. The system can be broadly divided into a Business Logic Layer, a Presentation Layer, and a Data Layer. The Data Layer deals with the data obtained, manipulated, and transmitted by the system, while the Business Logic Layer operates on the data and provides the overall system functionality required for connecting the user to the financial institution. The system includes a Presentation Layer used to present the information to the user. For the elements shown in FIG. 4, User Request Handler 401, Parser 403, and Cookie Manager 406 are used to form the Business Logic Layer, while Secure Tool Wrapper 402, Session Saver 405a and Session Storage Provider 405b, and AccessDB 407 are used to form the Data Layer. Output Deck 404 is used to form the Presentation Layer.

It is to be understood that while the various Figures included herein illustrate a preferred embodiment of the present invention, other implementations are possible of the novel concepts and functions provided herein while still within the course and scope of the present invention. While the invention has been described in connection with specific embodiments thereof, it will be understood that the invention is capable of further modifications. This application is intended to cover any variations, uses or adaptations of the invention following, in general, the principles of the invention, and including such departures from the present disclosure as come within known and customary practice within the art to which the invention pertains.

What is claimed is:

1. A method for maintaining a user session on a plurality of computing devices, comprising:
generating a unique session key on first instance of a user transmitting a request, wherein said unique session key is generated using a random number generator joined with a timing variable;
associating said unique session key with all data pertinent to the user session;
storing said session key and data pertinent to the user session in a common database; and
destroying the session key and any associated decryption key associated therewith.

2. A method for maintaining a user session on a plurality of computing devices, comprising:
providing a COM interface between said method and an OLE database;
providing a method to retrieve a connection string from a UDL file;
reading the location of the UDL file from a registry;
generating a unique key; and
storing said unique key with any associated session data in a common database.

3. A system for maintaining a user session on a plurality of computing devices, comprising:
means for generating a session key on first instance of a user transmitting a request to the system, wherein said session key is generated using a random number generator based on a timing variable joined with a GUID;
means for associating said unique session key with all data pertinent to the user session;
means for storing said session key and data pertinent to the user session in a common database; and
means for destroying the session key and any associated decryption key associated therewith.
